(19) United States
(12) Patent Application Publication
(10) Pub. No.: US 2013/0256262 A1
(43) Pub. Date: Oct. 3, 2013

(54) In Situ Manufacturing Process Monitoring System of Extreme Smooth Thin Film and Method Thereof

(71) Applicant: NATIONAL APPLIED RESEARCH LABORATORIES, Taipei (TW)

(72) Inventors: Chien-Nan Hsiao, Taichung City (TW); Po-Kai Chiu, Hsinchu City (TW); Da-Ren Liu, New Taipei City (TW); James Su, Hsinchu (TW); Fong-Zhi Chen, Hsinchu City (TW)

(73) Assignee: National Applied Research Laboratories, Taipei (TW)

(21) Appl. No.: 13/663,230

(22) Filed: Oct. 29, 2012

(30) Foreign Application Priority Data
Apr. 3, 2012 (TW) 101111942

(51) Int. Cl. B05D 3/10

(52) U.S. Cl. 216/37

(57) ABSTRACT

An in situ manufacturing process monitoring system of extreme smooth thin film and method thereof, comprising a coating device for coating a thin film on at least one substrate during a coating process, an ion figuring device for processing a surface polishing process on the thin film, a control device electrically coupled to the coating device and the ion figuring device respectively for controlling the coating device and the ion figuring device processing the coating process and surface polishing process by adjusting at least one device parameter of the coating device and the ion figuring device, and an in situ monitoring device electrically coupled to the control device for in situ monitoring at least one optical parameter of the thin film.

### CROSS-REFERENCE TO RELATED APPLICATION

This application claims the benefit of Taiwan Patent Application No. 101111942, filed on Apr. 3, 2012, in the Taiwan Intellectual Property Office, the disclosure of which is incorporated herein in its entirety by reference.

### BACKGROUND OF THE INVENTION

1. Field of the Invention

The present invention relates to a thin film manufacturing process, and more particularly to the field of an in situ manufacturing process monitoring system of extreme smooth thin film and a method thereof.

2. Description of Related Art

In the fields of mechanical industry, electronic industry or semiconductor industry, a thin film is formed on a surface of a material by various different methods to provide a certain property to the material, and the way of depositing such thin film is generally called “coating”. In a coating process, the coating particles are controlled in an atomic or molecular level to form a thin film, so as to obtain the thin film with special structure and functions. Coating is one of the common surface treatment methods applicable for the surface treatment of various molds, optical devices or semiconductor substrates which generally refers to a manufacturing process for growing a layer of homogenous or heterogeneous thin film on the surface of various metals, super hard alloys, ceramic materials and wafer substrates, and the manufacturing conditions can be changed according to the desired properties required by users.

At present, the optical thin film is mainly manufactured by a physical vapor deposition (PVD) that converts a thin film material from a solid state into a gas or ion state. The material in the gas or ion state is passed from an evaporation source through the vacuum chamber onto the surface of an object to be coated. After the material reaches the surface of the object to be coated, the material is deposited to gradually form a thin film. In general, the manufactured thin film has high purity and quality, and the manufacturing process of the coating must be completed in a high vacuum condition to achieve vacuum coating. Generally, in the vacuum coating process, the object to be coated is cleaned by an ultrasonic cleaner and the cleaned object is set on a fixture, and finally heated and vacuumed in the coating chamber. After a high vacuum is achieved, the coating is started.

In recent years, the physical and optical researches generally required an ultra-smooth thin film, particularly the noble metal (Pt or Ag) thin film, and the general manufacturing methods adopted are the coating and sputtering techniques, since the growing mechanism relates to an island growth, wherein the surface roughness (RMS) is up to 6 nm, and thus the surface roughness requires improvements to prevent the scattering loss of optical energy. However, there are many ways of improving the surface roughness of the thin film. In one of the common method, an operator can remove the coated substrate from the vacuum chamber and perform the ion figuring or coat an intermediate layer on the surface of the substrate. If the ion figuring method is used, the surface roughness can be improved significantly (RMS<3 nm) However, the process of the method will break the vacuum condition, and the drawback resides on that the surface of the thin film will come in contact with oxygen in the air and may be oxidized easily after breaking the vacuum condition, so as to affect the quality of the thin film, Another drawback resides on that after the substrate is removed from the vacuum chamber and being processed by the ion figuring, the thickness of the thin film cannot be monitored in situ during the coating process, and thus resulting in poor quality and low coating efficiency. At present, the most feasible conventional manufacturing method is to coat an intermediate layer additionally on the surface of the substrate in the thin film coating process. Although the result can reach the ultra-smooth scale (wherein the RMS is approximately equal to 0.60.8 nm), the material of the intermediate layer also will cause problems to the following experiments or applications, and the material of the intermediate layer can hardly be removed without damaging the substrate, and cannot further improve the surface roughness of the thin film to provide the resolution required for the application of the future optical devices. To overcome the aforementioned drawbacks, it is crucial to develop an in situ manufacturing process monitoring system of extreme smooth thin film and method featuring low cost, high precision and the potential for mass production.

### SUMMARY OF THE INVENTION

In view of the aforementioned problems of the prior art, one of the primary objectives of the present invention is to provide an in situ manufacturing process monitoring system of extreme smooth thin film, comprising: a coating device, for performing a coating process to form a thin film on at least one substrate; an ion figuring device, for performing a surface polishing process of the thin film; a control device, electrically coupled to the coating device and the ion figuring device, for adjusting at least one device parameter of the coating device and the ion figuring device to perform the coating process or the surface polishing process; and an in situ monitoring device, electrically coupled to the control device, for in situ monitoring at least one optical parameter of the thin film; wherein, the control device obtains the thickness of the thin film by using the optical parameter, and if the thickness reaches a first predetermined value during the coating process, the control device controls the coating device to stop the coating process and controls the ion figuring device to start the surface polishing process; if the thickness reaches a second predetermined value during the surface polishing process, the control device controls the ion figuring device to stop the surface polishing process; wherein, the coating device and the ion figuring device are contained in a vacuum chamber, and both the coating process and the surface polishing process are completed in the vacuum chamber without breaking the vacuum condition.

Preferably, the in situ monitoring device comprises a monitoring light generator, at least one alignment lens and a signal collector; wherein a monitoring light generated by the monitoring light generator passes through the at least one alignment lens and a window of the vacuum chamber to irradiate the substrate in the vacuum chamber, and then the monitoring light passing through or reflected from the substrate exits the window of the vacuum chamber and passes through the at least one alignment lens again to enter into the signal collector, and the signal collector determines whether the thickness of the thin film has reached the first predetermined value or the second predetermined value based on the collected optical signal according to a comparison chart of light transmittance and thin film thickness or a comparison chart of light reflectivity and thin film thickness.

Preferably, the at least one device parameter includes one selected from the collection of an ion beam current, a beam bias and a acceleration bias, and the ion beam current supplies energy to perform the coating process or the surface polishing process, and the beam bias supplies energy to dissociate an evaporation source into evaporation source ions, and the acceleration bias supplies energy to pump the evaporation source ions from the evaporation source towards the substrate.

Preferably, the substrate is a glass substrate, a silicon substrate, a metal substrate, a plastic substrate, or any combination of the above.

Preferably, the optical parameter includes a light transmittance or a light reflectivity.

To achieve another objective, the present invention further provides an in situ manufacturing monitoring method of thin film, comprising the steps of: using a coating device to perform a coating process to form a thin film on at least one substrate; using an in situ monitoring device to in situ monitor at least one optical parameter of the thin film, and using the at least one optical parameter to determine whether the thickness of the thin film has reached a first predetermined value; using a control device to control the coating device to stop the coating process and to control an ion figuring device to start a surface polishing process if the thickness of the thin film has reached the first predetermined value; using the in situ monitoring device to in situ monitor the at least one optical parameter of the thin film to determine whether the thickness of the thin film has reached a second predetermined value when the surface polishing process takes place; and using the control device to control the ion figuring device to stop the surface polishing process if the thickness of the thin film has reached the second predetermined value; wherein the coating device and the ion figuring device are contained in a vacuum chamber, and both the coating process and the surface polishing process are completed in the vacuum chamber without breaking the vacuum condition.

In summation, the in situ manufacturing process monitoring system of extreme smooth thin film and method in accordance with the present invention may have one or more of the following advantages:

(1) The in situ manufacturing process monitoring system of extreme smooth thin film and method of the present invention is based on the optical design, vacuum equipments and thin film material manufacturing process technologies to introduce the high vacuum ion assisted coating technology. In the coating and ion figuring processes, the optical parameter for in situ optically monitoring the thickness of the thin film is used to perform an ion figuring in the same coating chamber without breaking the vacuum condition, so as to reduce the surface roughness of the thin film to complete the manufacture of the thin film, preventing the oxidation of the thin film surface, enhancing the quality of the thin film, and simplifying the manufacturing process.

(2) In the in situ manufacturing process monitoring system of extreme smooth thin film and method of the present invention, the surface roughness (RMS) analyzed by the X-ray reflectometry (XRR) and the atomic force microscope (AMF) can enhance the super surface polishing (1 nm) up to the scale of 1 Å, which can meet the precision requirements for the researches and applications of physics and optics. Therefore, the present invention is an in situ monitoring thin film manufacturing process technology featuring low cost, high precision and the potential for mass production.

### BRIEF DESCRIPTION OF THE DRAWINGS

FIG. 1 is a block diagram of an in situ manufacturing process monitoring system of extreme smooth thin film in accordance with the present invention;

FIG. 2 is a schematic view of a coating process of an in situ manufacturing process monitoring system of extreme smooth thin film and a substrate thin film of a surface polishing process in accordance with the present invention;

FIG. 3 is a graph of an in situ monitoring full-band light transmittance versus a thin film thickness of an in situ manufacturing process monitoring system of extreme smooth thin film in accordance with the present invention;

FIG. 4 is a schematic view of a thin film surface of an in situ manufacturing process monitoring system of extreme smooth thin film and its data in accordance with the present invention; and

FIG. 5 is a flow chart of an in situ manufacturing monitoring method of thin film in accordance with the present invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, same numerals are used in the following preferred embodiment to represent same elements.

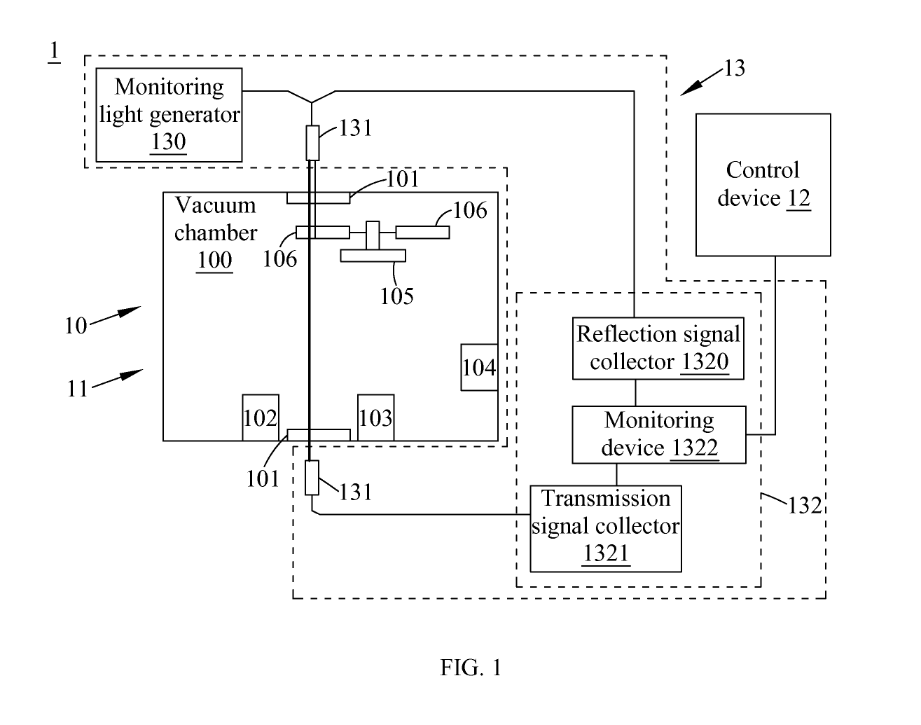

With reference to FIG. 1 for a block diagram of an in situ manufacturing process monitoring system of extreme smooth thin film in accordance with the present invention, the in situ manufacturing process monitoring system of extreme smooth thin film 1 comprises a coating device 10, an ion figuring device 11, a control device 12 and an in situ monitoring device 13. The coating device 10 performs a coating process to form a thin film on at least one substrate 106; the ion figuring device 11 performs a surface polishing process of the thin film; the control device 12 is electrically coupled to the coating device 10 and the ion figuring device 11 to adjust at least one device parameter of the coating device 10 and the ion figuring device 11 to perform a coating process or a surface polishing process; and the in situ monitoring device 13 is electrically coupled to control device 12 for in situ monitoring at least one optical parameter of the thin film.

In addition, the control device 12 obtains the thickness of the thin film by using an optical parameter. In the coating process, if the thickness has reached a first predetermined value, the control device will control the coating device 10 to stop the coating process and controls the ion figuring device 11 to start a surface polishing process. In the surface polishing process, if the thickness has reached a second predetermined value, the control device 12 controls the ion figuring device 11 to stop the surface polishing process to complete the process of coating and leveling the substrate 106.

Wherein, the coating device 10 and the ion figuring device 11 are contained in a vacuum chamber 100, and both the coating process and the surface polishing process are completed in the vacuum chamber 100 without breaking the vacuum condition.

It is noteworthy that the coating device 10 and the ion figuring device 11 include an ion source 102, an evaporation source 103, an electron gun 104, and a substrate carrier 105. In the coating process, the ion source 102 supplies energy to the evaporation source 103 to generate an evaporation source ion to be moved towards at least one substrate 106 fixed by the substrate carrier 105; the electron gun 104 provides neutralizing electrons to the evaporation source ion to neutralize the electric property of the substrate 106 to form a thin film.

On the other hand, the in situ monitoring device 13 may comprise a monitoring light generator 130, at least one alignment lens 131 and a signal collector 132, wherein a monitoring light generated by a monitoring light generator 130 is passed through at least one alignment lens 131 and then a window 101 of the vacuum chamber 100 to irradiate the substrate 106 in the vacuum chamber 100, and then penetrated through or reflected from the substrate 106, and the monitoring light is passed through at least one alignment lens 131 to enter into the signal collector 132, and the signal collector 132 determines whether the thickness of the thin film has reached a first predetermined value or second predetermined value of the collected optical signal according to a comparison chart of light transmittance and thin film thickness or a comparison of light reflectivity and thin film thickness, and the first or second predetermined value is provided to the control device 12 to adjust the device parameter of the coating device 10 or the ion figuring device 11.

It is noteworthy that, the signal collector 132 may comprise a reflection signal collector 1320, a transmittance signal collector 1321 and a monitoring device 1322. The reflection signal collector 1320 is provided to receive a monitoring light signal reflected from the substrate 106, and the transmittance signal collector 1321 is provided to receive a monitoring light signal penetrated through the substrate 106, and the monitoring device 1322 is provided to compile a monitoring light signal transmitted from the reflection signal collector 1320 or the transmittance signal collector 1321. In other words, the in situ monitoring method of the present invention performs a comparison by monitoring the monitoring light signal reflected from the substrate 106 or the monitoring light signal penetrated through the substrate 106 according to a comparison chart of light transmittance and thin film thickness or a comparison chart of light reflectivity and thin film thickness to obtain the thickness of the thin film on the substrate 106 during the coating process or the surface polishing process, and the user can determine whether to continue performing the coating process of the substrate 106, to stop the coating process to enter into the ion figuring, or to stop the ion figuring according to the thickness of the thin film obtained from the in situ monitoring, so as to complete coating the substrate 106 at this time. While a penetration monitoring method is adopted in the embodiment of the present invention, it should be understood that the present invention is not limited thereto.

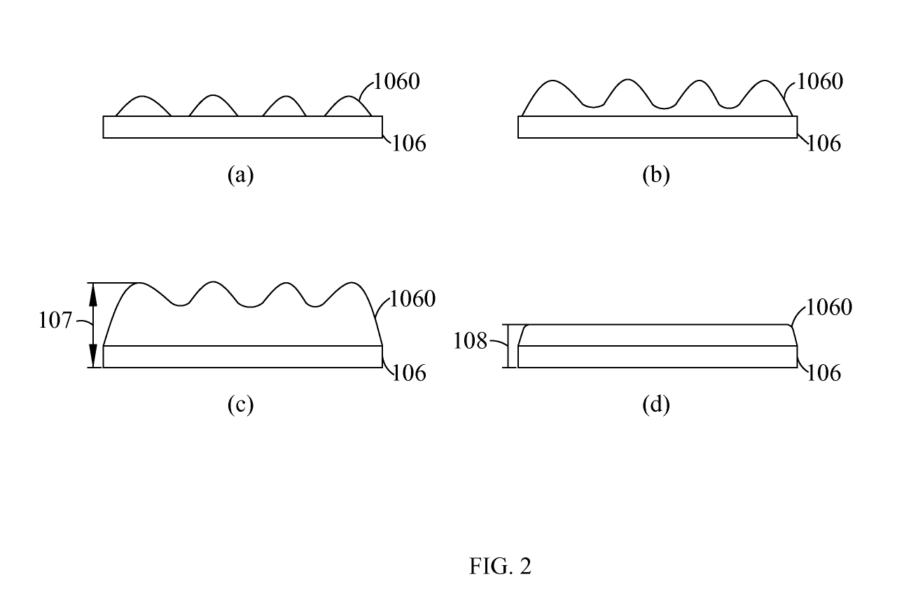

With reference to FIG. 2 for a schematic view of a coating process of an in situ manufacturing process monitoring system of extreme smooth thin film and a substrate thin film of a surface polishing process in accordance with the present invention, when the coating process starts, the control device 12 controls the operation of the coating device 10, such that the thin film 1060 can start growing on at least one substrate 106, while the in situ monitoring device 13 starts in situ monitoring the thin film 1060 on the substrate 106 in the vacuum chamber 100. In part (a) of FIG. 2, when the thin film 1060 starts growing on the substrate 106, an island growing mechanism is used, and the growth of the thin film 1060 is not continuous. As the coating process continues, the thin film 1060 can grow into a continuous and irregular surface, and the thickness of the thin film 1060 is increased continuously (as indicated in part (b) of FIG. 2). When the in situ monitoring device 13 monitors and determines that the thickness of the thin film 1060 has reached a first predetermined value 107 (as indicated in part (c) of FIG. 2), and the control device 12 can control the coating device 10 to stop the coating process and can control the ion figuring device 11 to start the surface polishing process. When the in situ monitoring device 13 monitors and determines that the thickness of the thin film 1060 has reached a second predetermined value 108 (as indicated in part (d) of FIG. 2), and the control device 12 can stop the ion figuring device 11 to complete the processes of coating and leveling the substrate 106.

In a preferred embodiment, the coating device 10 and the ion figuring device 11 can be the same device or different devices, but they can share one of the ion source 102 and the electron gun 106. For simplicity, the coating device 10 and the ion figuring device 11 in accordance with the preferred embodiment of the present invention use the same ion source 102 and electron gun 106, but the present invention is not limited thereto. The control device 12 can adjust at least one device parameter (such as an ion beam current, a beam bias or an acceleration bias) of the ion source 102 shared by the coating device 10 and the ion figuring device 11, so that the ion source 102 can be applied in the coating process or the surface polishing process to complete the processes of coating and leveling the substrate 106.

In a preferred embodiment, the coating process and the surface polishing process can be performed once or multiple times. In other words, the in situ manufacturing process monitoring system of extreme smooth thin film disclosed in the present invention can obtain the thickness of the thin film 1060 on the substrate 106 according to the optical parameter monitored by the in situ monitoring device 13, and both the coating process and the surface polishing process can be performed once or multiple times. For example, if a user wants to grow the thin film 1060 grown by the evaporation source 103 to a thickness equal to the first predetermined value 107, the surface polishing process is performed, and the thin film 1060 grown by the evaporation source 103 is cut and thinned to the second predetermined value 108, then the user further grow another thin film by the evaporation source 103 (which can be the same evaporation source or different evaporation sources) to a thickness equal to the third predetermined value, and the surface polishing process is performed, and the other thin film grown by the evaporation source 103 is cut and thinned to the fourth predetermined value. For simplicity, the embodiment of the present invention carries out the process once, but the present invention is not limited thereto.

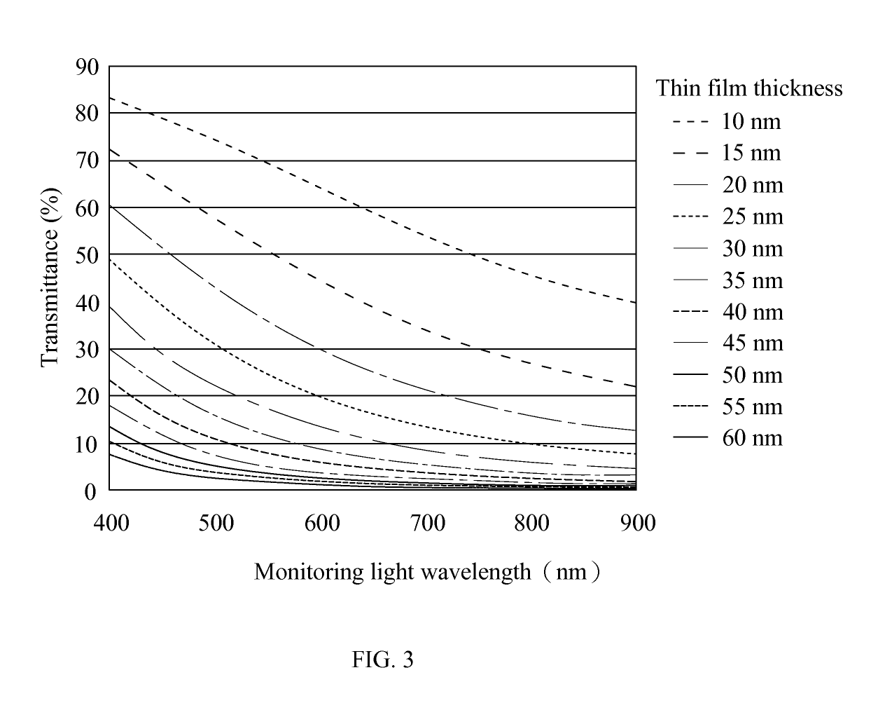

With reference to FIG. 3 for a graph of an in situ monitoring full-band light transmittance versus a thin film thickness of an in situ manufacturing process monitoring system of extreme smooth thin film in accordance with the present invention, the vertical axis represents light transmittance, and the horizontal axis represents different wavelengths of the monitoring light, and different lines in the figure represent the thicknesses of different thin films. When the coating process or surface polishing process is performed, the in situ monitoring device monitors the monitoring light signal reflected from the substrate or the monitoring light signal penetrated through the substrate (the following description of the preferred embodiment is illustrated by monitoring the monitoring light signal penetrated through the substrate, but the present invention is not limited thereto), and a comparison chart of light transmittance of the light signals and the thin film thickness is used to obtain the thickness of the current thin film by comparing the light signals with the chart. It should be understood that different substrate materials and different evaporation sources should have different light transmittance and thin film thickness comparison charts, and different light reflectivity and thin film thickness comparison charts. In the preferred embodiment of the present invention, silver (Ag) is used as the evaporation source, and a glass substrate is used for example, but the present invention is not limited thereto.

In a preferred embodiment, the comparison chart of light transmittance and thin film thickness is used for comparing the light transmittance to obtain the thin film thickness, and this method can select at least three monitoring lights with at least three monitoring light wavelengths, and can use the at least three monitoring lights for the irradiation of the substrate to perform the coating process or surface polishing process, so as to obtain the at least three light transmittances of the current at least three monitoring lights, and also can use the least square regression to analyze the at least three light transmittances, compare the nearest curves in the comparison charts between the at least three light transmittances and the light transmittance with the thin film thickness to derive the thickness of the thin film in real time. Advantageously, the in situ manufacturing process monitoring system of extreme smooth thin film of the present invention can use the aforementioned in situ monitoring method to obtain the thickness of the thin film on the substrate in real time, and facilitate users to determine whether the desired conditions of the thin film are satisfied, or the user has preset a parameter for the control device and the in situ monitoring device controls the current thin film on the substrate to reach the user's preset parameter of the thin film. Therefore, the present invention can provide an automatic thin film manufacturing process system that can perform a coating process or a surface polishing process. The present invention not only overcomes the drawbacks of the prior art that requires breaking the vacuum condition, and requires the use of the intermediate layer to achieve a better surface roughness of the thin film to meet the requirements of the thin film on the substrate, but also simplifies the manufacturing process of the thin film and lowers the manufacturing cost.

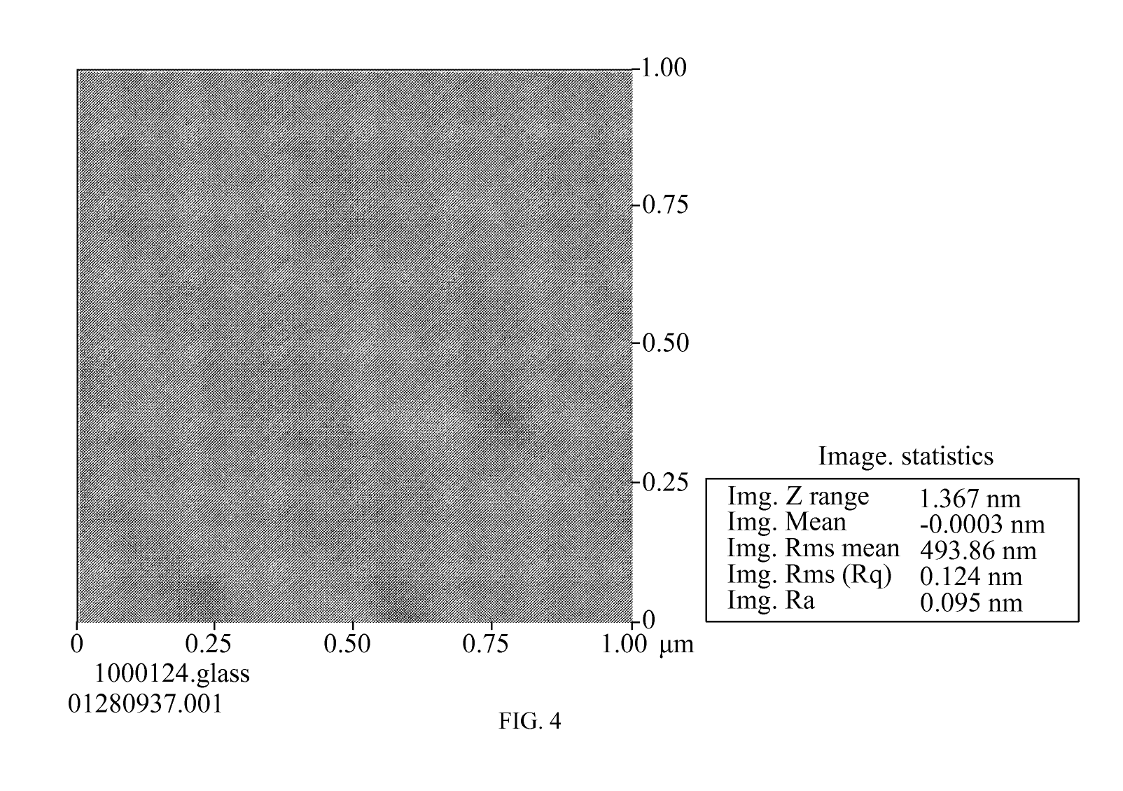

With reference to FIG. 4 for a schematic view of a thin film surface of an in situ manufacturing process monitoring system of extreme smooth thin film and its data in accordance with the present invention, after the thin film on the substrate is processed by the coating process and the surface polishing process, the surface roughness (RMS) of the thin film on the substrate can be analyzed by an atomic force microscope (AFM) or an X-ray diffractometry (not shown in the figure). In FIG. 4, a coating machine manufactured by Optorun Co., Ltd. Japan (Model No. OTFC-1800C/D) is used for manufacturing a thin film of a glass substrate, wherein silver Ag is used as the evaporation source, and the AFM is used to measure the data of the surface of the thin film. The device parameters used in the manufacture process of the thin film are listed below. During the coating process, the ion source current is approximately 900 mA, the beam bias is approximately 850 kv, and the acceleration bias is approximately 600 kv. During the surface polishing process, the ion source current is approximately 300 mA, the beam bias is approximately 500 kv, and the acceleration bias is approximately 600 kv. The thin film with the glass substrate manufactured by the in situ manufacturing process monitoring system of extreme smooth thin film of the present invention has a surface roughness (RMS) approximately 0.124 (up to the extremely smooth scale), which can satisfy the requirements for the researches and applications of the precision physics and optics.

Although the concept of the method for in situ monitoring an extreme smooth thin film manufacturing process system of the present invention has been described in the section of the in situ manufacturing process monitoring system of extreme smooth thin film, the description of the following flow chart is provided for illustrating the present invention more clearly.

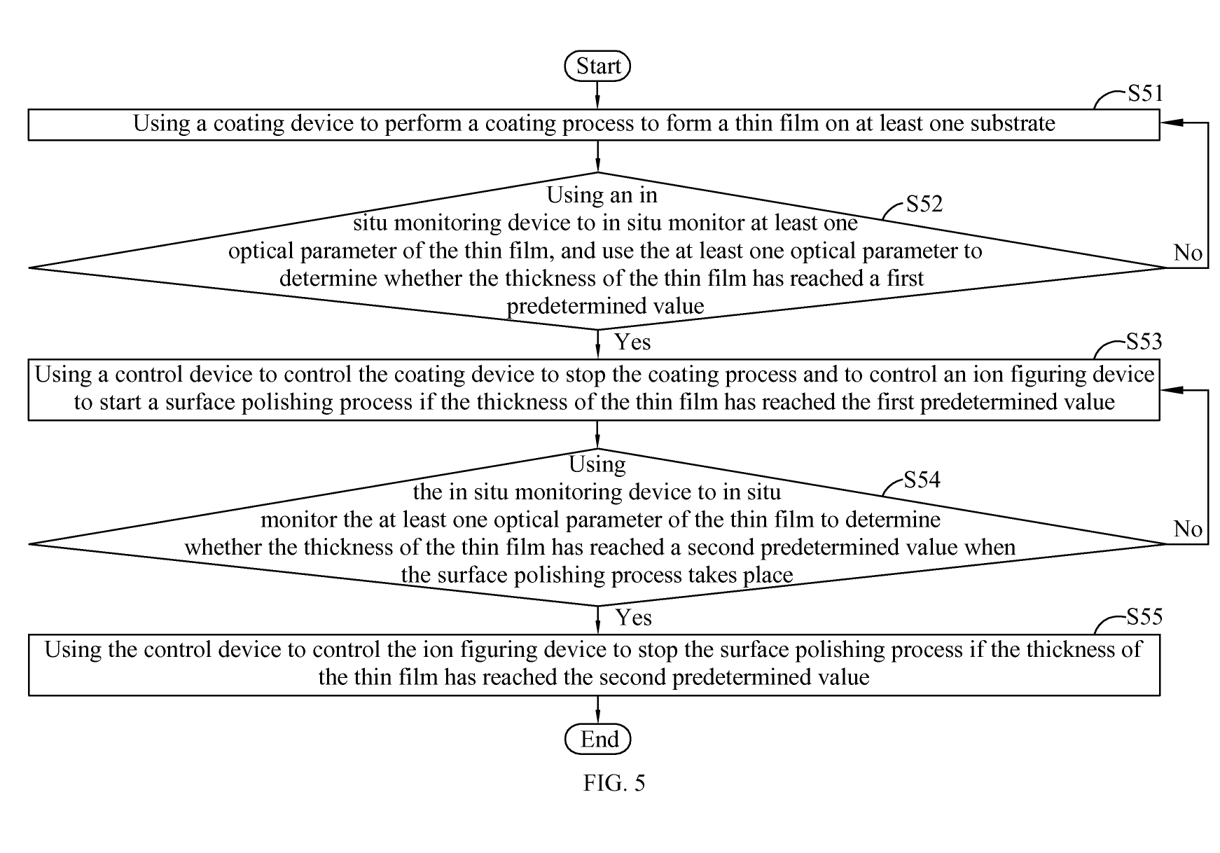

With reference to FIG. 5 for a flow chart of an in situ monitoring thin film manufacturing process method in accordance with the present invention, the method comprises the following steps:

S51: Using a coating device to perform a coating process to form a thin film on at least one substrate.

S52: Using an in situ monitoring device to in situ monitor at least one optical parameter of the thin film, and use the at least one optical parameter to determine whether the thickness of the thin film has reached a first predetermined value.

S53: Using a control device to control the coating device to stop the coating process and to control an ion figuring device to start a surface polishing process if the thickness of the thin film has reached the first predetermined value.

S54: Using the in situ monitoring device to in situ monitor the at least one optical parameter of the thin film to determine whether the thickness of the thin film has reached a second predetermined value when the surface polishing process takes place.

S55: Using the control device to control the ion figuring device to stop the surface polishing process if the thickness of the thin film has reached the second predetermined value.

In summation of the description above, the in situ manufacturing process monitoring system of extreme smooth thin film and method of the present invention have one or more of the following advantages:

(1) The in situ manufacturing process monitoring system of extreme smooth thin film and method of the present invention can obtain the thickness of the thin film and can in situ optically monitor the optical parameter of the thin film to perform an ion figuring in the same coating chamber without breaking the vacuum condition, so as to achieve the effects of reducing the surface roughness of the thin film to complete the manufacture of the thin film, preventing the oxidation of the thin film surface, enhancing the quality of the thin film, and simplifying the manufacturing process.

(2) In the in situ manufacturing process monitoring system of extreme smooth thin film and method of the present invention, the surface roughness (RMS) analyzed by the X-ray reflectometry (XRR) and the atomic force microscope (AMF) can enhance the super surface polishing (1 nm) up to the scale of 1 Å, which can satisfy the requirements for the researches and applications of the precision physics and optics.

Therefore, the present invention is an in situ monitoring thin film manufacturing process technology featuring low cost, high precision and the potential for mass production.

While the means of specific embodiments in the present invention has been described by reference drawings, numerous modifications and variations could be made thereto by those skilled in the art without departing from the scope and spirit of the invention set forth in the claims. The modifications and variations should be in a range limited by the specification of the present invention.

What is claimed is:

1. An in situ manufacturing process monitoring system of extreme smooth thin film, comprising:
a coating device, for performing a coating process to form a thin film on at least one substrate;
an ion figuring device, for performing a surface polishing process of the thin film;
a control device, electrically coupled to the coating device and the ion figuring device, for adjusting at least one device parameter of the coating device and the ion figuring device to perform the coating process or the surface polishing process; and
an in situ monitoring device, electrically coupled to the control device, for in situ monitoring at least one optical parameter of the thin film;
wherein, the control device obtains a thickness of the thin film by using the optical parameter, and if the thickness reaches a first predetermined value during the coating process, the control device controls the coating device to stop the coating process and controls the ion figuring device to start the surface polishing process;
if the thickness reaches a second predetermined value during the surface polishing process, the control device controls the ion figuring device to stop the surface polishing process;
wherein, the coating device and the ion figuring device are contained in a vacuum chamber, and both the coating process and the surface polishing process are completed in the vacuum chamber without breaking the vacuum condition.

2. The in situ manufacturing process monitoring system of extreme smooth thin film of claim 1, wherein the in situ monitoring device comprises a monitoring light generator, at least one alignment lens and a signal collector; wherein a monitoring light generated by the monitoring light generator passes through the at least one alignment lens and a window of the vacuum chamber to irradiate the substrate in the vacuum chamber, and then the monitoring light passing through or reflected from the substrate exits the window of the vacuum chamber and passes through the at least one alignment lens again to enter into the signal collector, and the signal collector determines whether the thickness of the thin film has reached the first predetermined value or the second predetermined value based on the collected optical signal according to a comparison chart of light transmittance and thin film thickness or a comparison chart of light reflectivity and thin film thickness.

3. The in situ manufacturing process monitoring system of extreme smooth thin film of claim 2, wherein the at least one device parameter includes one selected from the collection of an ion beam current, a beam bias and a acceleration bias, and the ion beam current supplies energy to perform the coating process or the surface polishing process, and the beam bias supplies energy to dissociate an evaporation source into evaporation source ions, and the acceleration bias supplies energy to pump the evaporation source ions from the evaporation source towards the substrate.

4. The in situ manufacturing process monitoring system of extreme smooth thin film of claim 1, wherein the substrate is a glass substrate, a silicon substrate, a metal substrate, a plastic substrate, or any combination of the above.

5. The in situ manufacturing process monitoring system of extreme smooth thin film of claim 1, wherein the optical parameter includes a light transmittance or a light reflectivity.

6. An in situ manufacturing monitoring method of thin film, comprising the steps of:
using a coating device to perform a coating process to form a thin film on at least one substrate;
using an in situ monitoring device to in situ monitor at least one optical parameter of the thin film, and using the at least one optical parameter to determine whether a thickness of the thin film has reached a first predetermined value;
using a control device to control the coating device to stop the coating process and to control an ion figuring device to start a surface polishing process if the thickness of the thin film has reached the first predetermined value;
using the in situ monitoring device to in situ monitor the at least one optical parameter of the thin film to determine whether the thickness of the thin film has reached a second predetermined value when the surface polishing process takes place; and
using the control device to control the ion figuring device to stop the surface polishing process if the thickness of the thin film has reached the second predetermined value;
wherein the coating device and the ion figuring device are contained in a vacuum chamber, and both the coating process and the surface polishing process are completed in the vacuum chamber without breaking the vacuum condition.

7. The in situ manufacturing monitoring method of thin film of claim 6, wherein the in situ monitoring device comprises a monitoring light generator, at least one alignment lens and a signal collector, and a monitoring light generated by the monitoring light generator passes through the at least one alignment lens and a window of the vacuum chamber to irradiate the substrate in the vacuum chamber, and then the monitoring light passing through or reflected from the substrate exits the window of the vacuum chamber and passes through the at least one alignment lens again to enter into the signal collector, and the signal collector determines whether the thickness of the thin film has reached the first predetermined value or the second predetermined value based on the collected optical signal according to a comparison chart of light transmittance and thin film thickness or a comparison chart of light reflectivity and thin film thickness.

8. The in situ manufacturing monitoring method of thin film of claim 7, wherein the at least one device parameter includes one selected from the collection of an ion beam current, a beam bias and a acceleration bias, and the ion beam current supplies energy to perform the coating process or the surface polishing process, and the beam bias supplies energy to dissociate an evaporation source into evaporation source ions, and the acceleration bias supplies energy to pump the evaporation source ions from the evaporation source towards the substrate.

9. The in situ manufacturing monitoring method of thin film of claim 6, wherein the substrate is a glass substrate, a silicon substrate, a metal substrate, a plastic substrate, or any combination of the above.

10. The in situ manufacturing monitoring method of thin film of claim 6, wherein the optical parameter includes a light transmittance or a light reflectivity.
